(19) United States
(12) Patent Application Publication
(10) Pub. No.: US 2005/0012995 A1
(43) Pub. Date: Jan. 20, 2005

(54) REAR PROJECTION DISPLAY APPARATUS

(76) Inventor: Kun-Rong CHANG, Miao-Li County (TW)

Correspondence Address: NAIPO (NORTH AMERICA INTERNATIONAL PATENT OFFICE), P.O. BOX 506, MERRIFIELD, VA, 22116, US

(21) Appl. No.: 10/710,403

(22) Filed: Jul. 8, 2004

(30) Foreign Application Priority Data
Jul. 14, 2003 (TW) 092212921

(51) Int. Cl. G03B 21/56

(52) U.S. Cl. 359/460

(57) ABSTRACT

A rear projection display apparatus includes a housing, an optical engine installed in the housing, a multi-curvatures reflection mirror, a plane mirror and a screen, in which a plurality of reflection faces with a different curvature radius are disposed at the surface of the multi-curvatures reflection mirror according to the lengths of optical paths. An image beam is provided by the optical engine and the light paths are reflected and bended to the plane mirror by the multi-curvatures reflection mirror after image deformation is corrected. Finally, the optical paths are reflected and bended again by the plane mirror and the image is displayed on the screen. Whereby, the thickness of the apparatus can be reduced and the image deformation can be improved.

### BACKGROUND OF INVENTION

1. Field of the Invention

The present invention relates to a rear projection display apparatus, and more particularly to a rear projection display apparatus using a multi-curvatures reflection mirror to reduce the thickness thereof.

2. Description of the Prior Art

Generally, an image is projected onto a screen after an image beam is yielded from an optical engine and an optical path is bended by mirrors in a general rear projection display apparatus. The thickness of the display device is reduced by bending the optical path to the screen through the mirrors.

Please refer to FIG. 1. Plane mirrors are used to bend an optical path in a conventional rear projection display device 10. A large plane mirror 11 is installed behind a screen 12 and a small plane mirror 13 is installed in front of the exit of an optical engine 14 to allow an image light emitted from the optical engine 14 can be projected onto the screen 12 through the reflections of the small plane mirror 13 and the larger plane mirror 11. However, the small plane mirror 13 needs to be installed by inclining an angle upwards to allow the image light to be able to be projected on the large plane mirror 11, and the large plane mirror 11 also needs to be obliquely installed so as to compensate for unequal length of optical paths. But, the inclined installments of the plane mirrors cause the thickness of a projection system to be increased so that the effect of the thickness reduction of the system is limited.

Please refer to FIG. 2. A large plane mirror 25 is installed parallel to a screen 20 in a rear projection display device 20 disclosed in Japan patent application disclosure No. 2001-51347. And then, a plurality of curvature mirrors (i.e. first convex mirror 21, second concave mirror 22 and third convex mirror 23) are installed between an optical engine 24 and the large plane mirror 25 to increase the optical path bending times so as to attain to the reduction of the thickness of a projection system and the extension of a picture. Furthermore, an image deformation caused from unequal lengths of optical paths can be compensated by adjusting the angle and position of the mirrors 21, 22 and 23. But, the precisions of the mirrors and the alignment between each two corresponding mirrors must be more tightly precisely tolerance-disposed accompanying the increases of the mirrors to avoid causing such as the deviation and the deformation of the image influencing the quality of the image. Consequently, it will cause the manufacturing cost of the curvature mirrors to be higher and the alignment adjusting time and complexity of each two corresponding mirrors to be increased.

### SUMMARY OF INVENTION

One object of the present invention is to provide a rear projection display device, using reflection faces with a different curvature radius disposed on a multi-curvatures reflection mirror to compensate the unequal lengths of optical paths so as to attain to the correction of image deformation.

Another object of the present invention is to provide a rear projection display apparatus, allowing the numbers of elements to be reduced and simplifying the aligning adjustment by replacing the function of a plurality of curvature mirrors with a multi-curvatures reflection mirror.

Still another object of the present invention is to provide a rear projection display mirror, bending optical paths by a multi-curvatures reflection mirror and a plane mirror installed parallel to a screen to attain to the reduction of the thickness of the apparatus and the enlargement of the area of the screen.

For attaining to the objects mentioned above, a rear projection display apparatus comprise a housing, an optical engine installed in the housing, a multi-curvatures reflection mirror, a plane mirror and a screen, in which a plurality of reflection faces with a different curvature radius are disposed at the surface of the multi-curvatures reflection mirror according to the lengths of optical paths. An image beam is provided by the optical engine and the light paths are reflected and bended to the plane mirror by the multi-curvatures reflection mirror after image deformation is corrected. Finally, the optical paths are reflected and bended again by the plane mirror and the image is displayed on the screen. Whereby, the thickness of the apparatus can be reduced and the image deformation can be improved.

### BRIEF DESCRIPTION OF DRAWINGS

The present invention can be more fully understood by reference to the following description and accompanying drawings, in which:

FIG. 1 is a schematic view, showing a rear projection display apparatus of the prior art;

FIG. 2 is a schematic view, showing another rear projection display apparatus of the prior art;

FIG. 3 is a schematic view, showing a rear projection display apparatus of a preferred embodiment according to the present invention;

FIG. 4 is a three-dimensional view, showing a multi-curvatures reflection mirror of a rear projection display apparatus of a preferred embodiment according to the present invention; and

FIG. 5 is a rear view, showing a rear projection display apparatus of a preferred embodiment according to the present invention.

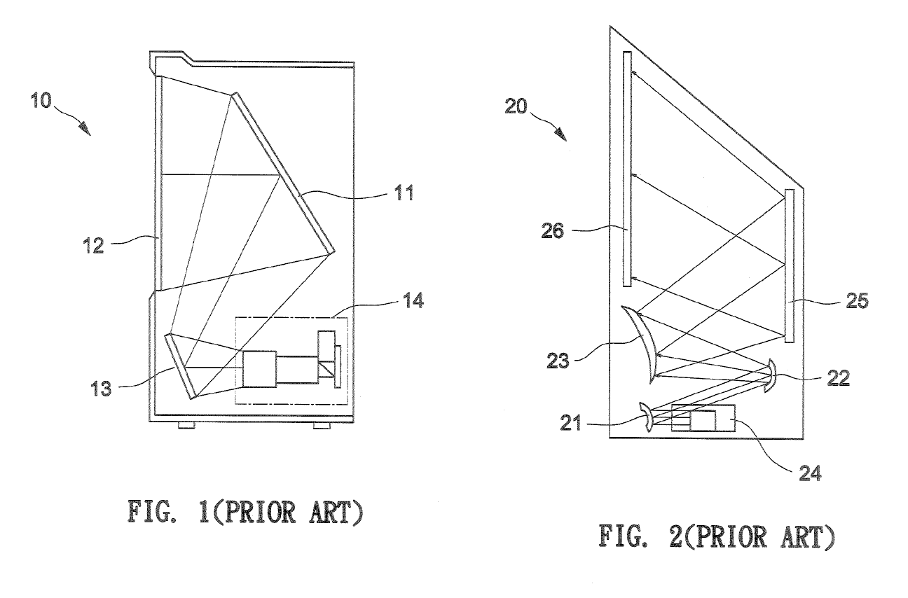

### DETAILED DESCRIPTION

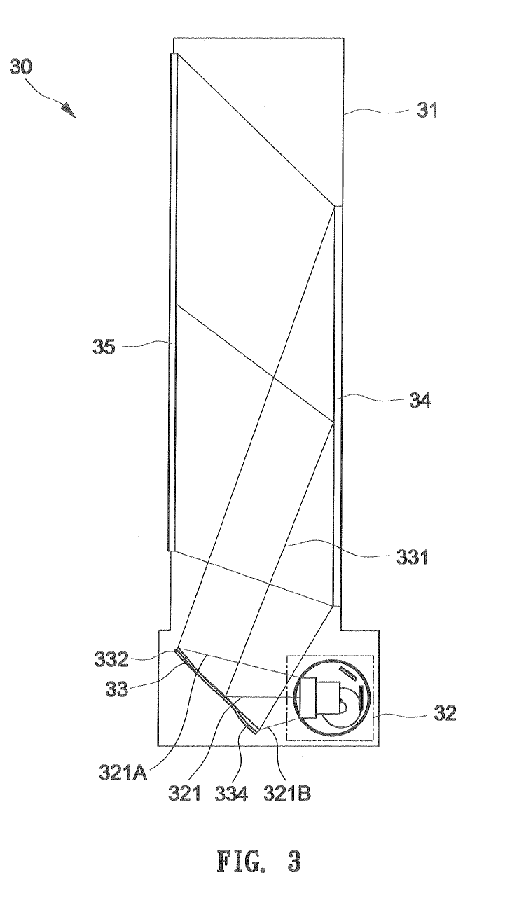

Please refer to FIG. 3. A rear projection display apparatus 30 comprises a housing 31, optical engine 32 installed in the housing 31, multi-curvatures reflection mirror 33, plane mirror 34 and screen 35.

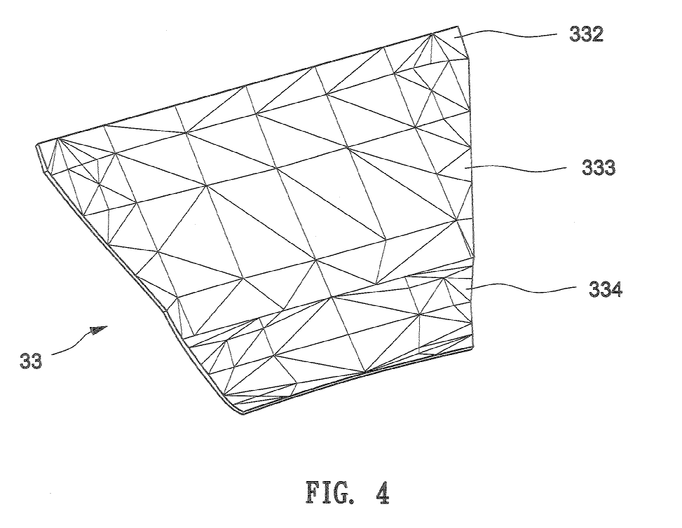

An image beam 321 is provide by the optical engine 32 and projected onto the multi-curvatures reflection mirror 33. The multi-curvatures reflection mirror 33 is installed at the optical paths of the image beam 321 and faces the plane mirror at a slanted angle. The image beam 321 is projected onto the plane mirror 34 after being reflected by the multi-curvatures reflection mirror 33. Please refer to FIG. 4. The multi-curvatures reflection mirror 33 is made of a plurality of reflection faces with different curvature radii (e.g. approximate concave reflection face 332, approximate plane mirror 333 and approximate convex mirror 334). The dimension of the curvature radius is decided by the length of the optical path from the optical engine 32 to the screen 35 and is inversely proportional to the distance of the optical path. The surface of the reflection mirror 33 is partitioned into a plurality of different zones (e.g. 332, 333 and 334) in a preferred embodiment according to the present invention and the dimension and the density of the partitioned zone can be decided by the variation range of the optical path and the curvature radius of each zone is calculated by means of the optical path. For example, if an optical path is longer (e.g. 321A), the concave reflection face 332 with a negative curvature radius is disposed on the surface of the multi-curvatures reflection mirror 33 passed by the optical path to allow the image to be shrunk depending on the inward curve of the curvature face when the image beam is projected on the reflection face 332 so as to cause the image shrinking ratio to be reduced; and if an optical path is shorter (e.g. 321B), the convex reflection face 334 with a positive curvature radius is disposed on the surface of the multi-curvatures reflection mirror 33 passed by the optical path to allow the image to be magnified depending on the outward curve of the curvature face when the image beam is projected on the reflection face 334 so as to cause the image magnifying ratio to be increased. Therefore, the unequal lengths of the optical paths are compensated through the multi-curvature reflection mirror 33 to allow magnifying ratio of the image to be the same so as to correct the deformation of the image. And, the plane mirror 34 is installed behind the screen 35 and parallel thereto to reflect an image beam 331 reflected from the multi-curvatures reflection mirror 33 onto the screen 35.

The image beam 321 emitted from the optical engine 32 is reflected by the multi-curvatures reflection mirror 33 and the plain mirror 34 to bend the optical paths thereof, and then, the image is reflected to display on the screen 35 to attain to the reduction of the thickness of the apparatus. And, because the plane mirror 34 is installed parallel to the screen 35, the unequal lengths of the optical paths are compensated by the variation of the curvatures on the surface of the multi-curvatures reflection mirror 33 so that the distance between the screen 35 and the plane mirror 341 can be reduced, and the variation of the curvature can allow the image to be magnified or shrunk so that the image can extend through the proper arrangement of the disposition of the curvatures. Thereby, the size of the screen can be increased.

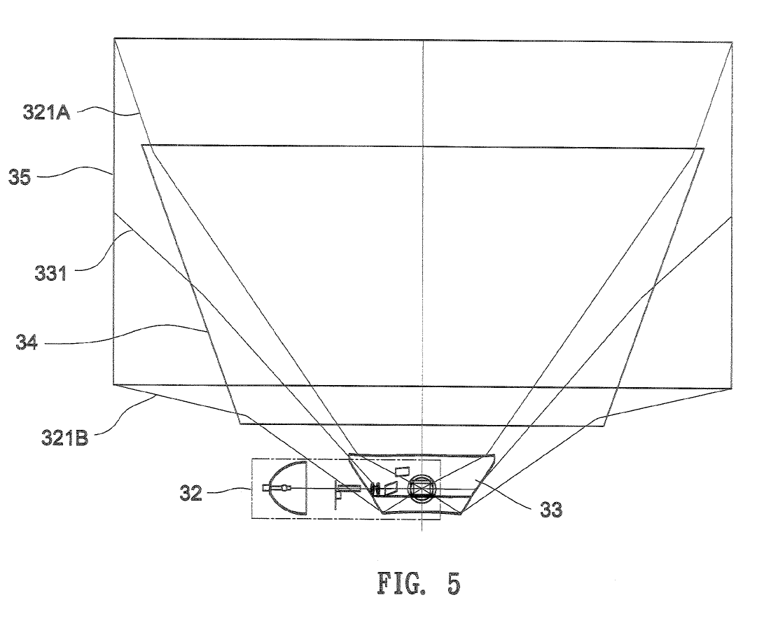

Besides, the image projected to the multi-curvature reflection mirror 33 is reflected to the plane mirror 34 by utilizing the reflection faces with different curvatures on the multi-curvatures reflection mirror 34 to allow the image to be magnified and shrunk properly to reach a same magnification ratio, and to compensate the image deformation yielded from the unequal lengths of the optical paths. Please refer to FIG. 5. The figure shows the result caused from the simulation processed on the rear projection display apparatus according to the present invention by an optics-design software (e.g. Zemax). It can be found that the image can be projected onto the screen 35 in a shape similar to the screen. Therefore, the correction of the image deformation can be achieved undoubtedly according to the present invention.

Replacing a plurality of curvature lenses in the prior art with the single multi-curvatures projection mirror 33 according to the present cab allow the numbers of the elements to be reduced and attain to the correction of the image deformation without the necessity of the adjustment of the relative position and angle between the curvature lenses. Therefore, the adjustment complexity and time can be lowered effectively, the cost of the display apparatus can be reduced and the alignment adjusting can be simplified.

It is noted that the rear projection display device described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

1. A rear projection display apparatus comprising:
an optical engine for providing an image beam;
a multi-curvature reflection mirror, installed at the optical paths of said image beam, and constituted with a plurality of reflection faces with different curvatures;
a screen, installed at said optical paths of said image beam reflected from said multi-curvature reflection mirror for displaying images; and
a housing for containing said optical engine, said multi-curvature reflection mirror, and said screen.

2. The rear projection display apparatus according to claim 1, wherein the curvature radius of each said reflection face is disposed depending on said optical path.

3. The rear projection display apparatus according to claim 1, wherein a plane mirror is installed behind said screen, and said plane mirror is positioned at said optical paths of said image beam reflected from said multi-curvature reflection mirror.

4. The rear projection display apparatus according to claim 3, wherein said plane mirror is installed parallel to said screen.
